(19) United States
(12) Patent Application Publication
(10) Pub. No.: US 2011/0289754 A1
(43) Pub. Date: Dec. 1, 2011

(54) FLOOR LINER FOR MAINTAINING CLEANLINESS OF COMMERCIAL AND INSTITUTIONAL KITCHENS

(76) Inventor: Thomas J. Cyprich, Wyoming, PA (US)

(21) Appl. No.: 13/103,803

(22) Filed: May 9, 2011

Related U.S. Application Data
(60) Provisional application No. 61/349,071, filed on May 27, 2010.

(51) Int. Cl. B23P 17/04; B32B 29/02; B32B 15/14; B32B 3/02

(52) U.S. Cl. 29/428; 442/412; 428/80; 428/124; 428/189; 428/61; 428/126

(57) ABSTRACT

A floor liner includes a layer of coated Kraft paper and a layer of nonwoven fabric, the layers being adhesively bonded together. Cut-outs are formed in the liner. The liner occupies the space beneath a piece of kitchen equipment, and absorbs spills and grease from such equipment. The liner can be removed and replaced, without disturbing the kitchen equipment. A plurality of metal tracks may be laid on top of the liner, to facilitate movement of the kitchen equipment onto, or away from, the liner.

### CROSS-REFERENCE TO PRIOR APPLICATION

Priority is claimed from U.S. Provisional Patent Application Ser. No. 61/349,071, filed May 27, 2010, the disclosure of which is hereby incorporated herein.

### BACKGROUND OF THE INVENTION

The present invention relates to the field of cleaning of commercial and institutional establishments, especially those which handle or process food.

A commercial food establishment, such as a fast-food restaurant, produces a considerable amount of grease, due to leakage or splattering of frying oil or other liquids. Also, pieces of food often fall to the floor, and then become lodged under cooking equipment. These problems often comprise health code violations, and eventually lead to health hazards, so they must be addressed promptly.

Various patents in the prior art have dealt with the problem of cleaning areas where food is prepared. In particular, it has been known to provide a mat which sits underneath a cooking apparatus, such as a barbecue grill, the mat comprising means for containing spills. Examples of such products are shown in U.S. Pat. Nos. 5,868,270 and 6,607,805, the disclosures of which are incorporated by reference herein. Other patents, such as U.S. Pat. Nos. 4,574,977, 5,434,339, and 5,605,247 illustrate the concept of a drip tray or mat for catching and containing spills. The disclosures of the latter patents are also incorporated by reference herein.

The present invention provides an improved floor liner, and method of using same, particularly suited for use in restaurants, for maintaining the cleanliness of such establishments, while minimizing the effort required.

### SUMMARY OF THE INVENTION

The floor liner of the present invention includes two layers, one layer being poly-coated Kraft paper, and the other layer being a non-woven fabric. The Kraft-paper side of the poly-coated Kraft paper is adhesively bonded to the non-woven fabric. Cut-outs are formed in the corners of the composite structure. The edges of two opposing sides may be folded over, so that two relatively narrow strips, extending along the opposing edges, have a material thickness which is effectively twice that of the main part of the liner. The liner is laid down in the space to be occupied by a piece of kitchen equipment, or other equipment, and a plurality of metal tracks are laid on top of the liner, in positions corresponding to wheels provided with the equipment. The equipment can then be easily rolled into the desired space, above the liner of the present invention, without disturbing the liner. The liner may have an area greater than the equipment under which the liner is installed, and the cut-outs prevent interference with corner legs of the equipment.

The coating of the Kraft paper is therefore located at the bottom, immediately adjacent the floor. The coating has the purpose of preventing the leakage of grease onto the surface of the floor. The non-woven fabric, which is located at the top of the floor liner, has the purpose of keeping relatively large amounts of grease in place.

In a more preferred embodiment, the edges of the liner are not folded over. Instead, there is provided a U-shaped structure formed of three flat metal strips, two of the strips defining tracks for accommodating the wheels of a kitchen appliance, and the other strip resting along a front edge of the liner, thus preventing the liner from being pulled up from the floor.

The present invention therefore has the primary object of improving the cleanliness of kitchens in commercial and/or institutional establishments.

The invention has the further object of reducing the effort required to maintain cleanliness in a commercial or institutional kitchen.

The invention has the further object of providing a floor liner which tends to capture and retain grease produced in a commercial or institutional kitchen.

The invention has the further object of providing a floor liner which is inexpensive to make, easy to install, and easily replaced.

The reader skilled in the art will recognize other objects and advantages of the present invention, from a reading of the following brief description of the drawings, and the detailed description of the invention.

### BRIEF DESCRIPTION OF THE DRAWINGS

FIG. 1 provides an exploded schematic diagram illustrating the floor liner of the present invention.

FIG. 2 provides a top view of the floor liner of the present invention.

FIG. 3 provides a perspective view, illustrating a preliminary step in the formation of a peripheral fold in the floor liner of the present invention.

FIG. 4 provides a fragmentary perspective view illustrating the formation of a peripheral fold in the floor liner of the present invention.

FIG. 5 provides a perspective view illustrating the floor liner of the present invention after peripheral folds have been formed.

FIG. 6 provides a perspective view illustrating a further step in the construction of the floor liner of the present invention, showing the formation of cut-outs at its corners.

FIG. 7 provides a perspective view showing the placement of a plurality of tracks, over the floor liner of the present invention, to facilitate the movement of equipment into a position over the floor liner.

FIG. 8 provides a fragmentary perspective view showing an item of kitchen equipment sitting in position over the floor liner of the present invention.

FIG. 9 provides a view similar to that of FIG. 8, but showing more detail of the floor, the liner, and the feet of the item of kitchen equipment.

FIG. 10 provides a top view of another embodiment of the present invention, in which a U-shaped track is laid down over the floor liner.

### DETAILED DESCRIPTION OF THE INVENTION

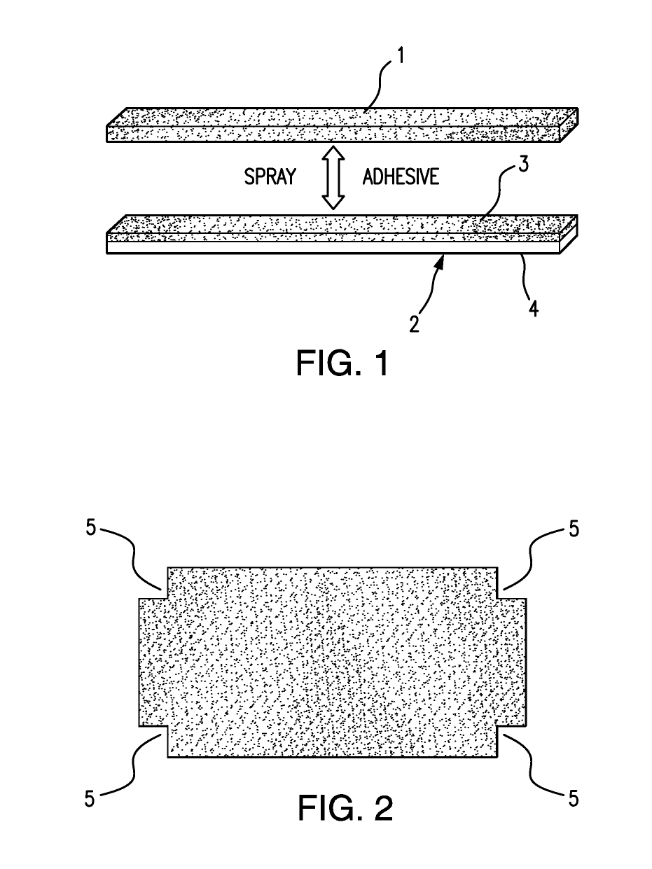

As shown in the exploded diagram of FIG. 1, the floor liner of the present invention includes layer 1 of non-woven poly fabric, and layer 2 of poly-coated Kraft paper. Reference numeral 3 indicates the uncoated Kraft paper side, which faces layer 1. Reference numeral 4 indicates the layer of poly coating that has been applied to the Kraft paper.

An example of a material which can be used as the poly-coated Kraft paper is Product No. S-5227, obtainable from the Uline Company, of Waukegan, Ill. (www.uline.com). This product is a roll of poly-coated Kraft paper, having a weight of 50 lb, the roll having dimensions of 36 inches×600 feet. The product is described as virgin Kraft paper coated with 10 lb gloss poly on one side. Other materials can be used in the invention, however, and the invention should not be deemed limited to this example.

The thicknesses of the layers, especially that of the poly coating, are not shown to scale in FIG. 1. Indeed, the poly coating on the Kraft paper is very thin compared to the thickness of the Kraft paper. The coated side of the Kraft paper is shiny. The purpose of the coating is to seal the paper at least partially, so as to prevent grease from leaking through the floor liner and onto the surface of the floor.

Layer 1 can be any non-woven fabric. The preferred material is the product commonly known as “Landscape Fabric”. In one example, this material can be the non-woven fabric sold under the trademark PREEN, by Lebanon Seaboard Corporation, of Lebanon, Pa. The invention is not limited to the use of the above-described fabric, however. The function of the non-woven fabric is to retain relatively large amounts of grease, thereby allowing the grease to harden, and facilitating its eventual removal by replacement of the liner.

The layers 1 and 2 are joined together by an adhesive, preferably one applied by spraying, as indicated in FIG. 1. The composite structure, formed by combining layers 1 and 2, is a generally flexible sheet, having a fabric texture on one side, and a shiny Kraft paper texture on the other. In one example, the adhesive used was the product sold under the trademark General Purpose 45 Spray Adhesive, by the 3M Company. However, the invention is not limited to a particular adhesive.

The floor liner of the present invention preferably includes cut-outs 5 formed at its corners, as shown in the top view of FIG. 2.

The purpose of the cut-outs is to make it feasible to use a floor liner having an area somewhat greater than that of the equipment under which the liner will be laid. More specifically, by making the floor liner large enough to extend beyond one or more side walls of the equipment, the liner can catch drippings flowing down said walls. Since most such equipment has legs at the corners, the cut-outs prevent interference with those legs. Thus, the floor liner can be laid down, in a flat condition, and without buckling, while still being wide enough to extend beyond the footprint of the equipment, so as to capture grease flowing down along the side walls.

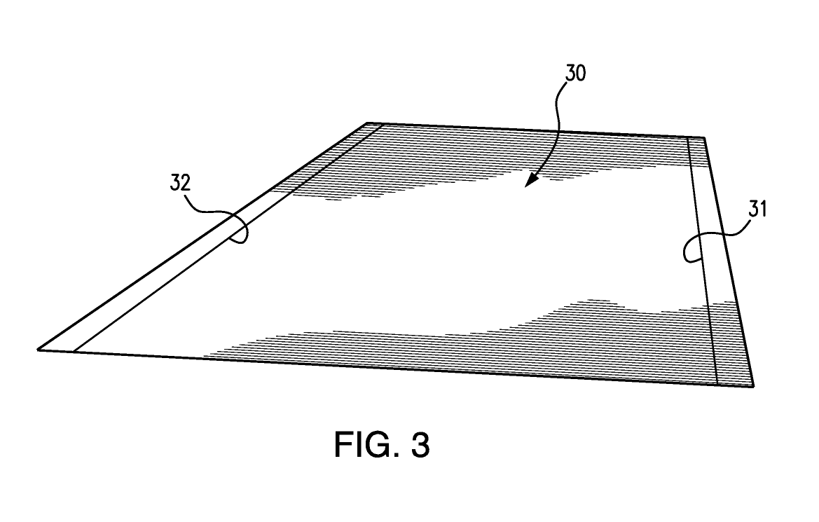

FIGS. 3-6 illustrate the major steps of a process of making a floor liner according to one embodiment of the present invention.

First, one measures the area occupied by the cooking or other equipment, under which the floor liner is to be placed. A piece of poly-coated Kraft paper is cut from a large roll, to conform to the size of the desired opening. Additional material is preferably added on each side to accommodate the cut-outs to be formed. The size of the additional material may be four inches, in one example, but the invention is not limited to a particular dimension.

Next, the black, non-woven poly fabric is cut, to match the size of the coated paper. The black non-woven poly fabric will eventually be the top layer, while the poly coated paper will be the bottom layer. The two layers are bonded together by using a general spray adhesive, and are pressed together, by hand or otherwise, to form a tight bond. The result is liner 30 of FIG. 3.

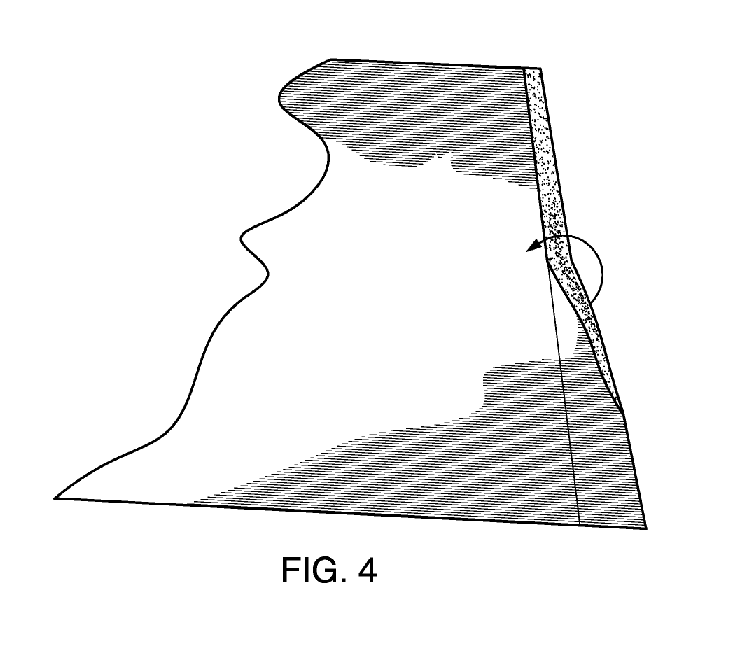

Next, two opposite sides of the liner are folded back. In performing this step, is convenient to draw lines 31 and 32, as shown in FIG. 3, which is displaced from the edge by twice the desired width of the fold. Then, the edge is folded over, as shown in FIG. 4. For example, if the width of the fold is selected to be one inch, the line will be drawn two inches from the edge of the sheet.

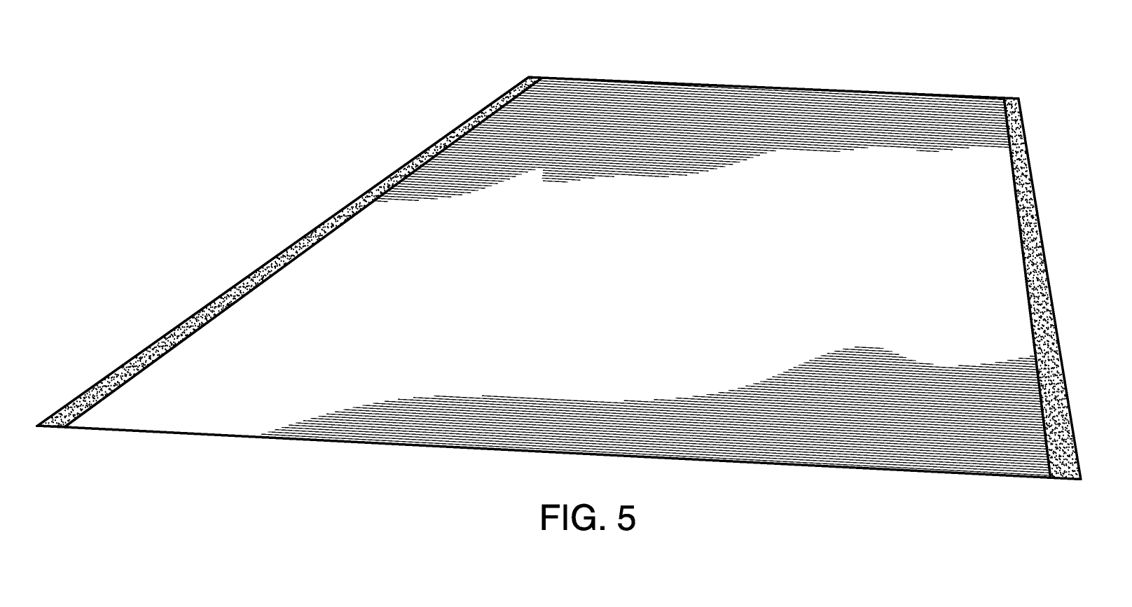

Note that, in these figures, the coated Kraft paper is facing upward. Also, the folds are formed for only two opposing sides of the sheet. When the folds have been completed, as shown in FIG. 5, two edges of the sheet effectively have a double thickness, along the width of the folds. The purpose of the fold is to give the liner more strength in the front and back, so that it will lie more firmly on the floor.

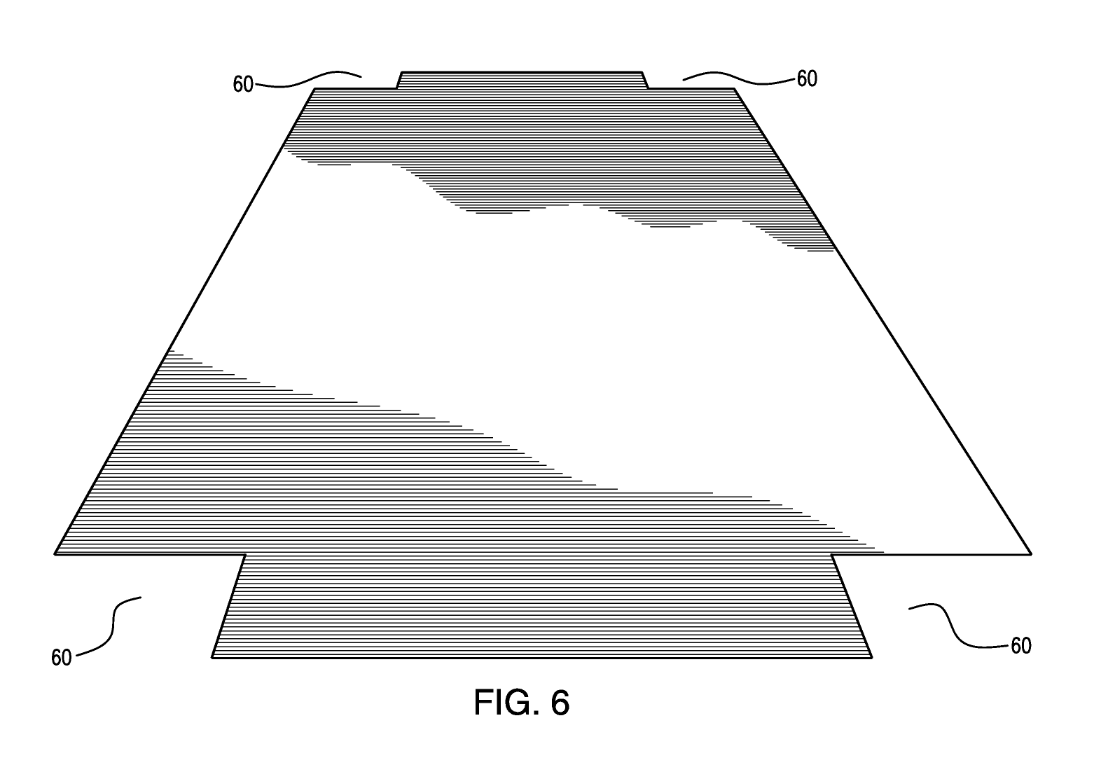

Finally, cut-outs are formed in each corner of the liner. FIG. 6 shows the liner with cut-outs 60, with the fabric side facing up.

In one example, the cut-out may have the dimensions of 4 inches×6 inches. These dimensions can be varied, within the scope of the invention.

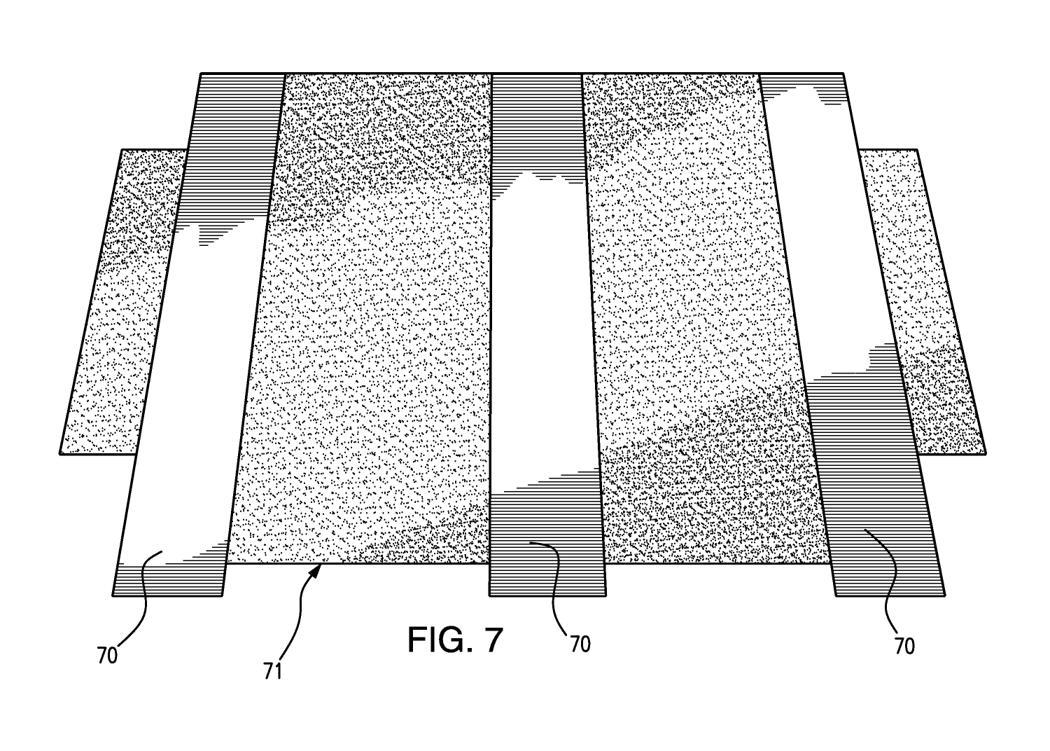

The floor liner 71 is then provided with metallic tracks, which support the feet of the equipment under which the liner sits. FIG. 7 shows three such tracks 70, which are generally flat pieces of metal. The tracks allow the cooking or other equipment to be pushed back into place without moving or wrinkling the liner. The tracks are simply laid on top of the floor liner. No separate attachment step is needed.

In one embodiment, the tracks are made of 18-gauge stainless steel, and are sized to be six inches wide, and one inch longer than the liner. This arrangement allows the wheels of the cooking or other equipment to be rolled on the track first, before encountering the liner. The number of tracks may be chosen to correspond to the number of wheels provided with the cooking or other equipment. The invention is not limited to a particular material, and is not to be deemed limited by the dimensions given above.

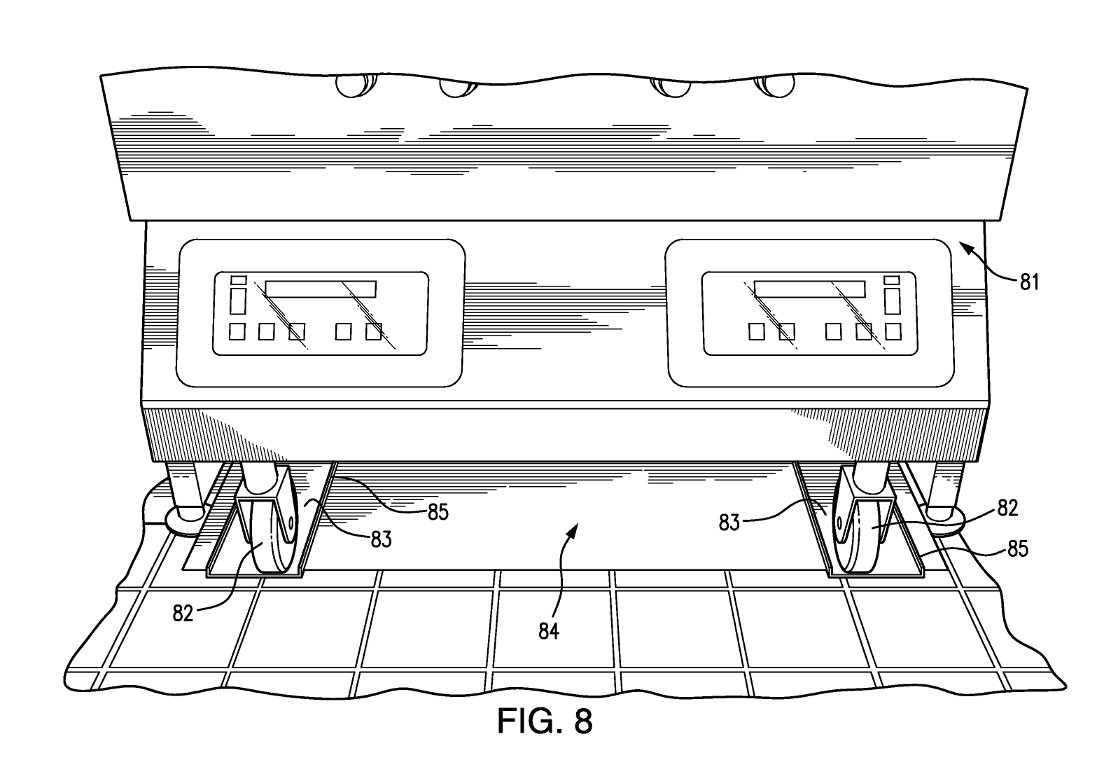

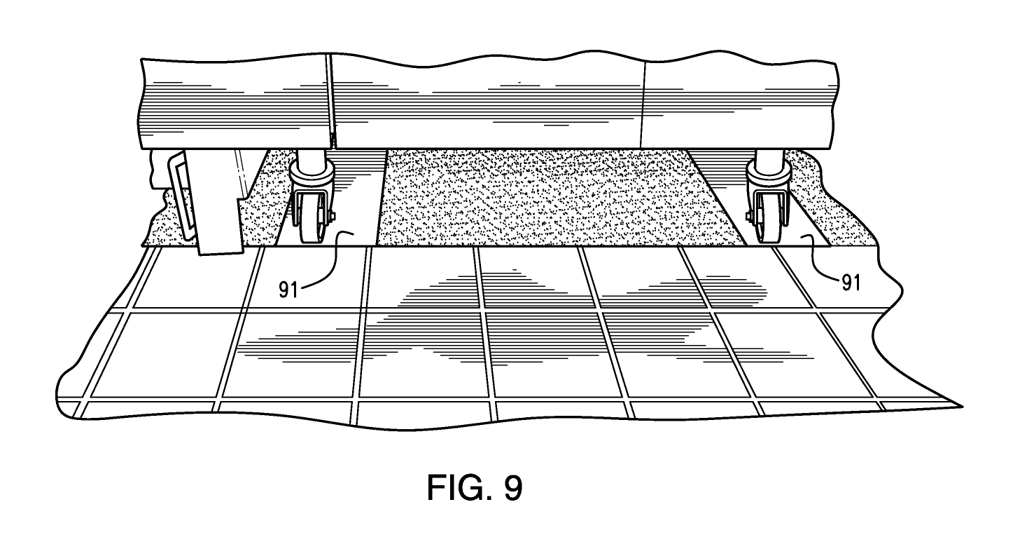

FIG. 8 shows an item of cooking equipment 81, with its wheels 82 resting on metal tracks 83 which sit on top of the floor liner 84 of the present invention. FIG. 9 shows a similar view, except that this view shows more detail of the wheels and less detail of the cooking equipment.

Note that some of the tracks include a flange 85 which extends generally perpendicularly to the floor. The preferred arrangement is to provide the tracks 91 without the flange, as is shown in FIG. 9, but either version can be used, within the scope of the invention.

The process described above may be replaced by a more automated process. For example, one can bond a continuous sheet or roll of coated Kraft paper with a continuous sheet or roll of non-woven fabric. The bonded structure can then be cut into the desired size. Finally, the cut-outs and folds are formed, to produce the desired floor liner.

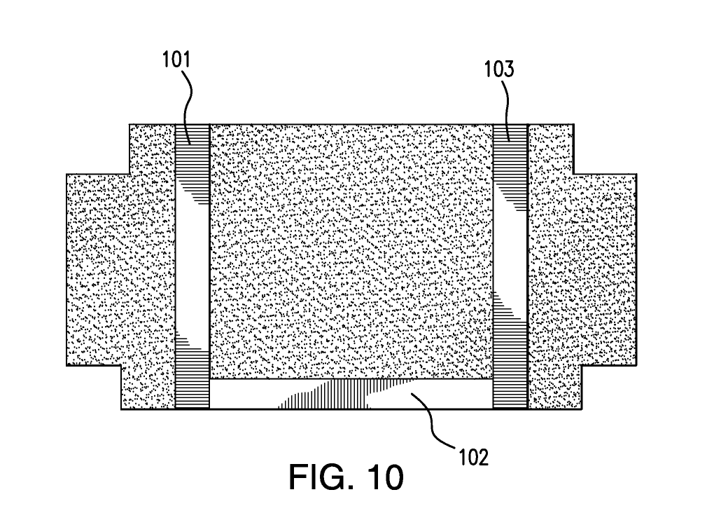

A more preferred embodiment is illustrated in the top view of FIG. 10. In this embodiment, the opposing edges of the liner are not folded over. Instead, there is provided a U-shaped track, comprising three metal strips 101, 102, 103. The strips are welded together, such that the U-shaped track defines a unitary structure. The U-shaped track is laid down onto the floor liner, and holds the liner in place, while also providing means for supporting the wheels of a kitchen appliance.

In particular, the strips 101 and 103 define tracks for the wheels of a kitchen appliance (such as the appliance shown in FIGS. 8 and 9). The cross-piece 102, being located along the front edge of the liner, holds that edge down, against the floor, and thereby eliminates the need to fold that edge over.

The floor liner of the present invention therefore substantially enhances the cleanliness of a commercial or institutional kitchen. The liner catches and absorbs most or all of the grease or other materials dropped from a stove or other appliance. When the liner has become saturated, meaning that it can no longer effectively absorb more grease, it can be easily removed and replaced by another liner.

The invention can be modified in various ways, as will be apparent to the reader skilled in the art. For example, the exact configuration of the metal tracks can be varied, to accommodate different configurations of kitchen equipment. The choice of Kraft paper, and the choice of the non-woven fabric, can be varied. The shape of the floor liner can be altered to suit the requirements of space, and to suit different configurations of kitchen equipment. Such modifications should be considered within the spirit and scope of the following claims.

What is claimed is:

1. A floor liner, comprising a layer of poly-coated Kraft paper, the layer of Kraft paper having a top side and a bottom side, the Kraft paper being poly-coated on the bottom side, the top side of the layer of Kraft paper being adhesively bonded to a layer of non-woven fabric.

2. The floor liner of claim 1, wherein the layers are generally rectangular, and wherein the layers have corners which include cut-out portions.

3. The floor liner of claim 1, wherein at least one edge of the floor liner is folded back over itself.

4. The floor liner of claim 3, wherein two opposite edges of the floor liner are folded back over themselves.

5. The floor liner of claim 2, wherein there are a plurality of metal tracks laid on top of the floor liner.

6. The floor liner of claim 5, wherein the tracks are welded together to form a unitary U-shaped structure.

7. A method of maintaining cleanliness in a commercial or institutional kitchen, comprising:
a) providing a floor liner comprising a layer of poly-coated Kraft paper, the layer of Kraft paper having a top side and a bottom side, the Kraft paper being poly-coated on the bottom side, the top side of the layer of Kraft paper being adhesively bonded to a layer of non-woven fabric,
b) placing the floor liner on a floor where an item of cooking equipment is to be positioned,
c) positioning at least one metal track on the floor liner, the track comprising a generally flat, elongated piece of metal, the track being positioned in a location corresponding to a wheel of said item of cooking equipment, and
d) moving the item of cooking equipment over the floor liner, such that the wheel of said item rests on said track.

8. The method of claim 7, wherein there are at least two tracks, and wherein step (c) includes arranging the tracks in a spaced-apart configuration on the floor liner.

9. The method of claim 7, wherein there are two tracks connected by a metallic cross-piece, and wherein step (c) includes arranging the tracks in a spaced-apart configuration on the floor liner, such that the cross-piece lies along an edge of the floor liner.

10. The method of claim 7, wherein the item of cooking equipment has a plurality of legs, and wherein the floor liner has corners which include cut-out portions, and wherein step (d) includes positioning the item of cooking equipment such that the legs occupy spaces where the floor liner is not present.

11. A method of maintaining cleanliness in a commercial or institutional kitchen, comprising:
a) providing a floor liner comprising a layer of poly-coated Kraft paper, the layer of Kraft paper having a top side and a bottom side, the Kraft paper being poly-coated on the bottom side, the top side of the layer of Kraft paper being adhesively bonded to a layer of non-woven fabric,
b) placing the floor liner on a floor where an item of cooking equipment is to be positioned,
c) positioning an item of cooking equipment over the floor liner.

12. The method of claim 11, wherein the item of cooking equipment has a plurality of legs, and wherein the floor liner has corners which include cut-out portions, and wherein step (c) includes positioning the item of cooking equipment such that the legs occupy spaces where the floor liner is not present.

13. The method of claim 11, wherein step (b) is followed by the step of placing a U-shaped structure, defined by a plurality of metal strips, onto the floor liner, and wherein step (c) comprises rolling the cooking equipment onto at least some of said metal strips.

14. The method of claim 13, wherein the step of placing the U-shaped structure on the floor liner includes placing a portion of the U-shaped structure along a front edge of the liner.
